(19) United States
(12) Patent Application Publication
(10) Pub. No.: US 2023/0081725 A1
(43) Pub. Date: Mar. 16, 2023

(54) INTELLIGENT INSIGHTS ACROSS APPLICATIONS

(71) Applicant: SAP SE, Walldorf (DE)

(72) Inventors: Karthik RAMACHANDRAN, Bangalore (IN); Michael KASTNER, Keltern (DE)

(21) Appl. No.: 17/474,270

(22) Filed: Sep. 14, 2021

(51) Int. Cl. H04L 12/24

(52) U.S. Cl. CPC H04L 41/0813; H04L 41/0846; H04L 41/0866; H04L 41/12

(57) ABSTRACT

Systems and methods include detection, at a first application executed by a first computing system, of a change to a second object of a second application executed by a second computing system, determination of whether to identify related objects based on the change to the second object, querying, if it is determined to identify related objects based on the change to the second object, of a graph of relations between objects of the first application and objects of the second application to determine third objects of the first application which are affected by the change to the second object, and presentation of the determined third objects.

### BACKGROUND

Traditional computing system architectures include one or more servers executing applications which access data stored in one or more database systems. Users interact with the applications to view, create and update the data in accordance with desired functionality. The servers may be located on-premise and the data may conform to a particular schema. Such applications may communicate with one another and be developed in order to ensure interoperability therebetween.

Modern architectures support the decoupling of their constituent applications. For example, an enterprise may utilize on-premise applications and cloud-based applications, some of which are provided by a same vendor and some of which are provided by different vendors. The data schemas utilized by the applications may differ as well. Such heterogenous communication protocols and data schemas hinder meaningful communication between applications. In particular, it becomes difficult to identify correlations between changes in one application and processes governed by another application.

Systems are desired to efficiently facilitate the establishment of correlations between data of disparate applications and to identify issues within one application based on changes to data in another application.

### BRIEF DESCRIPTION OF THE DRAWINGS

FIG. 1 is a block diagram of an architecture including a reusable component to derive inter-application insights according to some embodiments.

FIG. 2 is a block diagram of a reusable component to derive inter-application insights according to some embodiments.

FIG. 3 is a flow diagram of a process to derive inter-application insights according to some embodiments.

FIG. 4 is a view of a user interface to establish object relations according to some embodiments.

FIG. 5 is a view of a user interface to present a derived insight according to some embodiments.

FIG. 6 depicts a cloud-based system architecture according to some embodiments.

FIG. 7 is a block diagram of a hardware system according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments provide a reusable component to facilitate the establishment of relations between objects of disparate applications. The reusable component may also identify changes within data of a first application and, based on these changes and on user-defined rules, identify issues (or insights) within a second application based on rules or otherwise.

According to one non-exhaustive example, a first application governs construction activity for a given project. A second application in the system landscape separately manages purchase orders. The first and second applications execute independently from and do not communicate with one another. According to some embodiments, an insight generator service detects a change to a purchase order in the second system to a “Rejected” state and also identifies a relation between the purchase order and construction activity for a specific floor within a specific building. Based on the change, the relation, and a predefined rule, the insight generator service generates an indication that construction activity within the particular floor may be impacted due to the change to the purchase order in the second application.

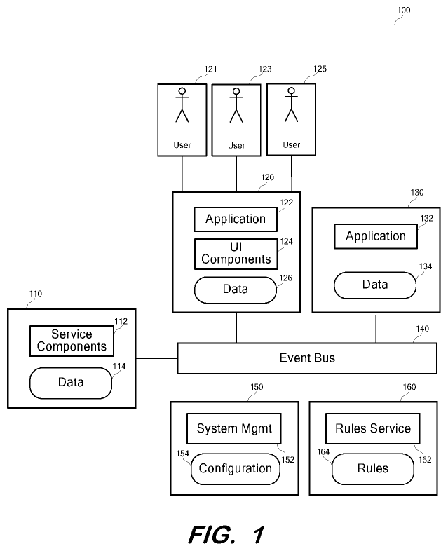

FIG. 1 is a block diagram of an architecture of system 100 according to some embodiments. Each illustrated element of system 100 may be implemented using any suitable combination of computing hardware and/or software that is or becomes known. Such a combination may include implementations which apportion computing resources elastically according to demand, need, price, and/or any other metric. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service).

For example, server 110 may comprise an on-premise hardware server, a cloud based virtual machine, or combinations thereof. Server 110 includes program code of reusable service components 112. Generally, service components 112 include software components which provide services to reusable user interface (UI) components which may be used by applications within a system landscape. As will be described herein, service components 112 provide functionality to user interface components for defining relations between objects of disparate systems, and for identifying and presenting issues, or insights, based on those relations and on changes to objects within the disparate systems.

Data 114 may include the defined relations, configuration information usable to access disparate systems, and any other data required by service components 112. Data 114 may be stored proximate to server 110 or remote therefrom, in a distributed storage system or otherwise.

Servers 120 and 130 execute applications 122 and 132. An application as described herein may comprise program code executable to provide any suitable or desired functionality based on stored data. Each application described herein manages data according to a corresponding object schema, in which the data managed by a given application is encapsulated within object instances. An object may comprise metadata describing the structure of data which defines a corresponding logical entity (e.g., a purchase order, a task), while an object instance comprises data conforming to the structure and specific to a single instance of the logical entity (e.g., purchase order 2344, task 123). As described above, the disparate applications of system 100 may conform to different object schemas.

Applications 122 and 132 are executed within separate execution environments. Accordingly, systems for facilitating meaningful interoperability between applications 122 and 132 were not previously available.

According to some embodiments, application 122 accesses reusable plug-in UI components 124. A user of application 122 may thereby access UIs for interacting with service components 112 via application 122. Advantageously, a developer of application 122 need not code its own UIs for accessing service components 112. UI components 124 may be similarly used by other applications executing on server 120 or on other servers such as application 132.

Servers 120 and 130 may be implemented in any suitable manner. In one example, server 120 is a virtual machine provided by a same cloud service which provides a virtual machine for server 110 and accessible under a same cloud sub-account. Server 130 may comprise an on-premise system operated by a third party.

Each of servers 110, 120 and 130 are configured to communicate with event bus 140. In this regard, and according to some examples, applications 122 and 132 may be coded to transmit specific events to event bus 140 in response to changes to particular object instances defined by object type, data filters, or otherwise. In this regard, service components 112 may be coded to subscribe to events on event bus 140 which may relate to the generation of insights as will be described below.

Server 150 executes program code of system management service 152, and system management service 152 manages configuration 154. Configuration 154 may provide information which enables an application to communicate with other applications executing within system 100. For example, each application may be associated with a destination name, and configuration 154 may associate each destination name with a uniform resource identifier and authentication information (e.g., credentials and an authentication mechanism) which may be used to access the associated application.

Server 160 executes program code of rules service 162. Rules service 162 manages rules 164. An application executing within the system 100 may access rules service 162 to define rules which indicate whether a change to a particular object instance of a particular application should trigger generation of an insight by a reusable component such as one of service components 112. System management service 152 and rules service 162 may be executed by a same server and one or both of service 152 and service 162 may execute within a server which also provides other applications such as server 120 or server 130.

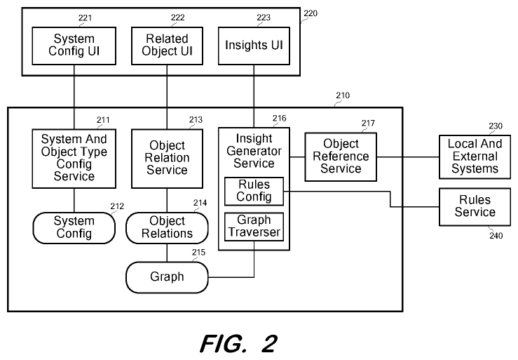

FIG. 2 is a block diagram of service components 210 and UI components 220 according to some embodiments. Service components 210 and UI components 220 may comprise implementations of service components 112 and UI components 124 according to some embodiments.

An administrator (e.g., user 121) may access system configuration UI component 221 via application 122 to configure the applications and systems within a system landscape architecture using system and object type configuration service 211 of service components 210. The thusly-configured configuration information is stored in system configuration repository 212.

An end user (e.g., user 123) may access object relation service 213 via related object service UI component 222 to discover objects existing within various other systems within the same landscape and to define relations between the objects of the other systems and objects of the system in which component 200 resides. The relations are stored in object relations repository 214. Graph 215 may be generated based on the object relations of object relations repository 214.

Insight generator service 216 of service components 210 accesses object reference service 217 to detect changes to object instances of local and external systems 230. Object reference service 217 may detect such changes by subscribing to an event bus to which local and external systems 230 publish events such as particular changes to particular objects instances. Insight generator service 216 also provides for configuration of rules to be executed by rules service 240 and a graph traverser to query graph 215. Accordingly, insight generator service 216 may generate insights based on changes to objects determined by object reference service 217, rules executed by rules service 240 and object relations determined from graph 215. Configuration of the rules and/or definition of insights may be performed by a user via insights user interface component 223. Any generated insights may also be presented to other users (e.g., user 125) through insights user interface component 223.

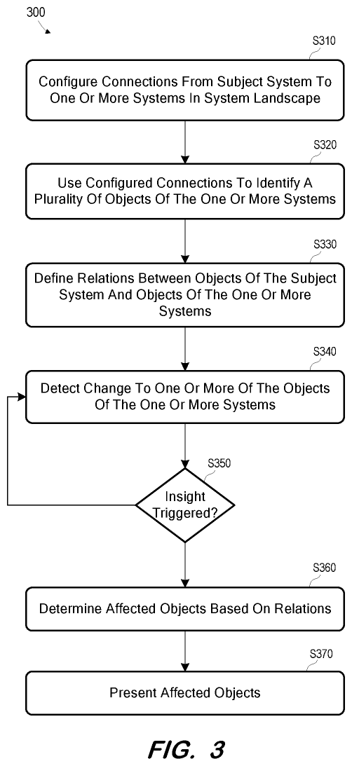

FIG. 3 comprises a flow diagram of process 300 to provide insights to a subject system based on changes to other systems within a same system landscape according to some embodiments. Process 300 and all other processes mentioned herein may be embodied in program code executable by one or more processing units (e.g., processor, processor core, processor thread) and read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S310, connections to one or more other systems in a system landscape are configured. According to some embodiments, an account administrator accesses system configuration user interface component 221 to instruct system and object type configuration service 211 of service components 210 to define, for each other system in the system landscape, a system, a system type and a destination name. The definitions are stored in system configuration repository 212.

Next, at S320, the configured connections may be used to identify objects within each of the one or more systems. For example, an end user may access related object service user interface component 222 to instruct object relations service 213 to access and present objects of the other systems within the system landscape. In order to determine the objects within a particular system, object relations service 213 identifies a destination name associated with the system within system configuration repository 212. Object relations service 213 then accesses system management service 152 to retrieve information from configuration 154 which is associated with the destination name. the configuration information is used to make an API call to the system which requests the objects of that system.

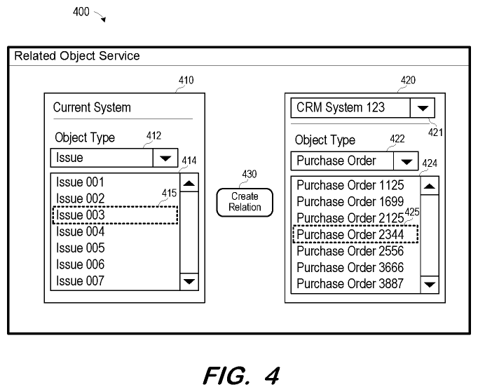

Relations between objects of the subject system and objects of the one or more other systems are defined at S330. FIG. 4 is a view of user interface 400 presented by related object service user interface component 222 according to some embodiments of S330. An end user may, for example, have operated a web browser to access a uniform resource locator associated with application 122, operated application to access related object service user interface component 222 of insight services UIs, and received user interface 400 in response.

User interface 400 includes area 410 associated with the current (“subject”) system with which the user is interacting. Area 410 includes dropdown field 412 for specifying an object type of the schema of the current system. The metadata defining the objects of the current system may be accessed using known techniques since related object service user interface component 222 is executing in a same environment as the current system. In the example, the selected object type is Issue and a list of Issue object instances is therefore provided in area 414. As indicated by dotted line 415, the user has selected object instance Issue 003.

User interface 400 also includes area 420 for selecting another system within the system landscape and an object instance of that system. Specifically, drop down field 421 allows a user to specify a particular system within the system landscape. The systems available via dropdown field 421 are those for which a corresponding configuration exists in system configuration repository 212. According to some embodiments, upon selection of a particular system using dropdown field 421, the selected system is accessed by object relation service 213 of service components 210 as described above with respect to S320 to determine all of the available objects of the system, and this object relation service 213 returns this information to related object service user interface component 222 of insight services UIs 134.

In the present example, the user has operated dropdown field 422 to select objects of the type Purchase Order. Accordingly, area 424 displays identifiers of all available purchase order instances of the selected system. The user has selected instance Purchase Order 2344 as indicated by dotted line 425.

The user may then select control 430 to create a relation between the two selected object instances. For example, selection of control 430 may result in object relation service 213 creating a corresponding relation within object relations repository 214. The user may continue to operate user interface 400 to define relations between object instances of the current system and object instances of one or more other systems. It should be noted that object relations repository 214 may include relations between a same object instance of the current system and more than one object instances of another system and/or one or more object instances of one or more other systems.

The relations created at S330 are in addition to those already created within the application with respect to the objects managed by the application. In the present example, it will be assumed that, within the current application, an object instance Project Element 008 is associated with Task 001, Task 002 and Task 003, and that Task 001 is in turn associated with Issue 003, which is a “material insufficient” issue. All of these relations may also be stored in object relations repository 214.

Returning to process 300, flow pauses at S340 to detect a change to one or more of the objects of the one or more systems. In some implementations of S340, an administrator configures object reference service 217 to listen for specific types of changes to specific objects. For example, object reference service 217 may be instructed to listen for events associated with Purchase Order object types having a status which has changed to Blocked. Moreover, in this example, object reference service 217 is configured to call rules service 240 in case such a change is detected. Accordingly, at least one external system is also coded to publish such status changes to event bus 140 so that the changes can be detected by object reference service 217 of the current system.

It will be assumed that, at S340, a change to a status of an instance of a Purchase Order object (i.e., Purchase order 2344) is detected. The changed status may be cached within object reference service 217 and, as described above, rules service 240 is then called. Next, at S350, it is determined whether the change requires triggering of an insight. If not, flow returns to S340 to listen for a next change.

It will be assumed that a rule has been previously configured which triggers generation of an insight if a status of an object of type Purchase Order of a particular system type has changed to Blocked. Accordingly, at S360, insight generator service 216 determines objects affected by the change based on the relations stored in object relations repository 214. In particular, insight generator service 216 queries graph 215 to determine objects affected by the cached status change of Purchase Order 2344 to Blocked.

In the above-described example, Issue object Issue 001 is affected by changes to Purchase Order 2344 due to the configured relation between the two objects. Issue 001 is in turn related to Task 001 which is related to Project Element 008 as also described above. At S370, the affected objects are presented to a user, via insights user interface component 223.

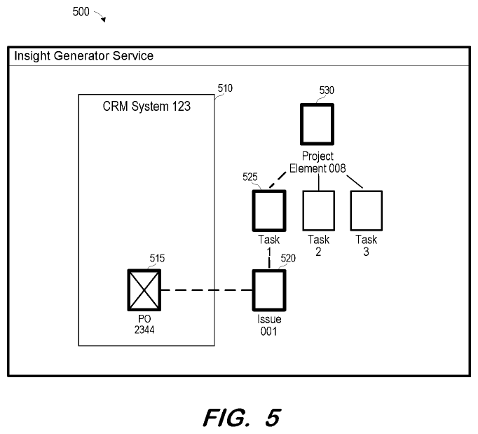

FIG. 5 is a view of user interface 500 presenting affected objects according to some embodiments. Area 510 of user interface 500 represents the external system in which a change was detected. Accordingly, area 510 includes icon 515 representing changed Purchase Order object 2344. User interface 500 also shows icons 520, 525 and 530 associated with affected object instances determined from object relations repository 214. User interface 500 thereby provides insights as to the effect of the change to Purchase Order object 2344 within the current system.

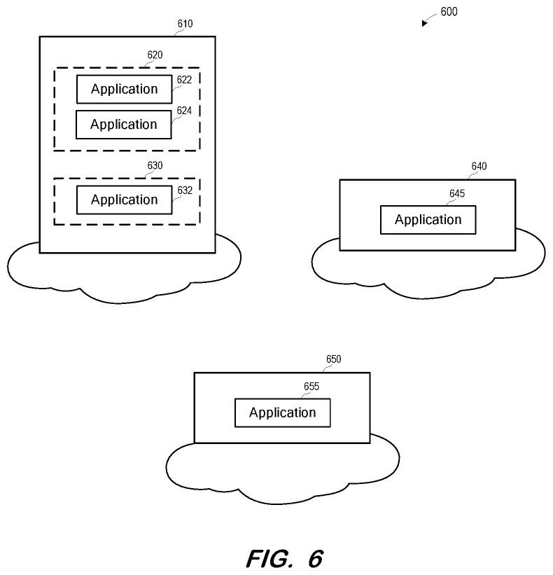

FIG. 6 is a diagram of cloud-based architecture 600 according to some embodiments. Each component of cloud-based architecture 600 may be implemented by any number of distributed servers, storage systems, virtual machines, etc., and the resources allotted to each component may expand or contract elastically as is known in the art of cloud deployments.

For example, server system 610 may comprise one or more blade servers providing virtual machines 620 and 630 which execute applications 622 and 624 and application 632, respectively. In some embodiments, virtual machine 620 executes applications accessible via one cloud tenant subaccount while virtual machine 630 executes applications accessible via a second cloud tenant subaccount. Servers 640 and 650 may be operated by different entities and may comprise public or private cloud servers.

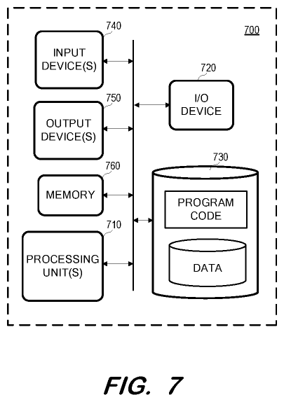

FIG. 7 is a block diagram of a computing system which may implement a server according to some embodiments. System 700 may comprise a general-purpose computing apparatus and may execute program code to perform any of the functions described herein. System 700 may be implemented by a distributed cloud-based server and may include other unshown elements according to some embodiments.

System 700 includes processing unit(s) operatively coupled to an I/O device 720, data storage device 730, one or more input devices 740, one or more output devices 750 and memory 760. I/O device 720 may facilitate communication with external devices, such as an external network, the cloud, or a data storage device. Input device(s) 740 may comprise, for example, a keyboard, a keypad, a mouse or other pointing device, a microphone, knob or a switch, an infra-red (IR) port, a docking station, and/or a touch screen. Input device(s) 740 may be used, for example, to enter information into hardware system 700. Output device(s) 750 may comprise, for example, a display (e.g., a display screen) a speaker, and/or a printer.

Data storage device 730 may comprise any appropriate persistent storage device, including combinations of magnetic storage devices (e.g., magnetic tape, hard disk drives and flash memory), optical storage devices, Read Only Memory (ROM) devices, and RAM devices, while memory 760 may comprise a RAM device.

Data storage device 730 stores program code executed by processing unit(s) 710 to cause system 700 to implement any of the components and execute any one or more of the processes described herein. Embodiments are not limited to execution of these processes by a single computing device. Data storage device 730 may also store data and other program code for providing additional functionality and/or which are necessary for operation of hardware system 700, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A method comprising:
detecting, at a first application executed by a first computing system, a change to a second object of a second application executed by a second computing system;
determining whether to identify related objects based on the change to the second object;
if it is determined to identify related objects based on the change to the second object, querying a graph of relations between objects of the first application and objects of the second application to determine third objects of the first application which are affected by the change to the second object; and
presenting the determined third objects.

2. A method according to claim 1, further comprising:
determining the relations between objects of the first application and objects of the second application by:
determining a configuration of the second computing system;
using the configuration to determine the objects of the second application;
presenting the objects of the second application to a user; and
receiving user input indicating the relations between objects of the first application and objects of the second application.

3. A method according to claim 1, further comprising:
instructing the first application to detect changes to the second object of the second application.

4. A method according to claim 1, wherein determining whether to identify related objects based on the change to the second object comprises:
transmitting information indicative of the change to the second object to a rules service; and
receiving, from the rules service and based on the transmitted information, an instruction to identify related objects based on the change to the second object.

5. A method according to claim 1, further comprising:
detecting, at the first application executed by the first computing system, a change to a fourth object of a third application executed by a third computing system;
determining whether to identify related objects based on the change to the fourth object;
if it is determined to identify related objects based on the change to the fourth object, querying a graph of relations between objects of the first application and objects of the third application to determine fifth objects of the first application which are affected by the change to the fourth object; and
presenting the determined fifth objects.

6. A method according to claim 5, further comprising:
determining the relations between objects of the first application and objects of the second application by:
determining a configuration of the second computing system;
using the configuration to determine the objects of the second application;
presenting the objects of the second application to a user; and
receiving user input indicating the relations between objects of the first application and objects of the second application; and
determining the relations between objects of the first application and objects of the third application by:
determining a second configuration of the third computing system;
using the second configuration to determine the objects of the third application;
presenting the objects of the third application to the user; and
receiving second user input indicating the relations between objects of the first application and objects of the third application.

7. A method according to claim 6, further comprising:
instructing the first application to detect changes to the second object of the second application and to detect changes to the fourth object of the third application.

8. A non-transitory computer-readable medium storing program code executable by a processing unit to cause a first computing system to:
detect, at a first application executed by the first computing system, a change to a second object of a second application executed by a second computing system;
determine whether to identify related objects based on the change to the second object;
if it is determined to identify related objects based on the change to the second object, query a graph of relations between objects of the first application and objects of the second application to determine third objects of the first application which are affected by the change to the second object; and
present the determined third objects.

9. A medium according to claim 8, the program code executable by a processing unit to cause the first computing system to:
determine the relations between objects of the first application and objects of the second application by:
determine a configuration of the second computing system;
use the configuration to determine the objects of the second application;
present the objects of the second application to a user; and
receive user input indicating the relations between objects of the first application and objects of the second application.

10. A medium according to claim 8, the program code executable by a processing unit to cause a first computing system to:
instruct the first application to detect changes to the second object of the second application.

11. A medium according to claim 8, wherein determination of whether to identify related objects based on the change to the second object comprises:
transmission of information indicative of the change to the second object to a rules service; and
reception, from the rules service and based on the transmitted information, of an instruction to identify related objects based on the change to the second object.

12. A medium according to claim 8, the program code executable by a processing unit to cause a first computing system to:
detect, at the first application executed by the first computing system, a change to a fourth object of a third application executed by a third computing system;
determine whether to identify related objects based on the change to the fourth object;
if it is determined to identify related objects based on the change to the fourth object, querying a graph of relations between objects of the first application and objects of the third application to determine fifth objects of the first application which are affected by the change to the fourth object; and
present the determined fifth objects.

13. A medium according to claim 12, the program code executable by a processing unit to cause a first computing system to:
determine the relations between objects of the first application and objects of the second application by:
determine a configuration of the second computing system;
use the configuration to determine the objects of the second application;
present the objects of the second application to a user; and
receive user input indicating the relations between objects of the first application and objects of the second application; and
determine the relations between objects of the first application and objects of the third application by:
determine a second configuration of the third computing system;
use the second configuration to determine the objects of the third application;
present the objects of the third application to the user; and
receive second user input indicating the relations between objects of the first application and objects of the third application.

14. A medium according to claim 13, the program code executable by a processing unit to cause a first computing system to:
instruct the first application to detect changes to the second object of the second application and to detect changes to the fourth object of the third application.

15. A computing system comprising:
one or more processing units; and
a memory storing program code executable by the one or more processing units to cause the computing system to:
detect, at a first application executed by the computing system, a change to a second object of a second application executed by a second computing system;
determine whether to identify related objects based on the change to the second object;
if it is determined to identify related objects based on the change to the second object, query a graph of relations between objects of the first application and objects of the second application to determine third objects of the first application which are affected by the change to the second object; and
present the determined third objects.

16. A computing system according to claim 15, the program code executable by the one or more processing units to cause the computing system to:
determine the relations between objects of the first application and objects of the second application by:
determine a configuration of the second computing system;
use the configuration to determine the objects of the second application;
present the objects of the second application to a user; and
receive user input indicating the relations between objects of the first application and objects of the second application.

17. A computing system according to claim 15, the program code executable by the one or more processing units to cause the computing system to:
instruct the first application to detect changes to the second object of the second application.

18. A computing system according to claim 15, wherein determination of whether to identify related objects based on the change to the second object comprises:
transmission of information indicative of the change to the second object to a rules service; and
reception, from the rules service and based on the transmitted information, of an instruction to identify related objects based on the change to the second object.

19. A computing system according to claim 15, the program code executable by the one or more processing units to cause the computing system to:
detect, at the first application executed by the computing system, a change to a fourth object of a third application executed by a third computing system;
determine whether to identify related objects based on the change to the fourth object;
if it is determined to identify related objects based on the change to the fourth object, querying a graph of relations between objects of the first application and objects of the third application to determine fifth objects of the first application which are affected by the change to the fourth object; and
present the determined fifth objects.

20. A computing system according to claim 19, the program code executable by the one or more processing units to cause the computing system to:
determine the relations between objects of the first application and objects of the second application by:
determine a configuration of the second computing system;
use the configuration to determine the objects of the second application;
present the objects of the second application to a user; and
receive user input indicating the relations between objects of the first application and objects of the second application; and
determine the relations between objects of the first application and objects of the third application by:
determine a second configuration of the third computing system;
use the second configuration to determine the objects of the third application;
present the objects of the third application to the user; and
receive second user input indicating the relations between objects of the first application and objects of the third application.
